(19) United States
(12) Patent Application Publication
(10) Pub. No.: US 2010/0152971 A1
(43) Pub. Date: Jun. 17, 2010

(54) STEERING CONTROL APPARATUS

(75) Inventors: Kohtaro Shiino, Isehara-shi (JP); Toshiro Yoda, Higashimatsuyama-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Automotive Systems, Ltd.

(21) Appl. No.: 12/637,882

(22) Filed: Dec. 15, 2009

(30) Foreign Application Priority Data
Dec. 16, 2008 (JP) 2008-319188

(51) Int. Cl. G06F 19/00; B62D 5/30

(52) U.S. Cl. 701/41; 180/405

(57) ABSTRACT

A steering control apparatus includes a rack shaft connected to steerable wheels and having rack teeth in a given axial range, a first steering mechanism having a reduction gear and a first electric motor to apply a drive force to the rack shaft through the reduction gear, a second steering mechanism having a second electric motor, a power cylinder equipped with hydraulic pressure chambers, an oil pump driven by the second electric motor to provide a supply of hydraulic oil to the hydraulic pressure chambers such that the power cylinder applies a driving force to the rack shaft in accordance with a pressure difference between the hydraulic pressure chambers and a switching unit capable of selectively switching the supply of hydraulic oil from the oil pump to the hydraulic pressure chambers, and a control device that controls the first and second electric motors in response to a driver's steering operation.

### BACKGROUND OF THE INVENTION

The present invention relates to a steering control apparatus for an automotive vehicle and, more particularly, to a steering control apparatus having two independently operable steering mechanisms.

Japanese Laid-Open Patent Publication No. 2002-154442 discloses one type of steering control apparatus, called a dual pinion type electric power steering apparatus that has two rack-and-pinion steering mechanisms. More specifically, the dual pinion type electric power steering apparatus includes a rack shaft having first and second rack teeth formed at axially different positions, a first pinion shaft coupled to a steering wheel and having pinion teeth engaged with the first rack teeth, a second pinion shaft having pinion teeth engaged with the second rack teeth, an electric motor coupled to the second pinion shaft via a reduction gear, a torque sensor mounted on the first pinion shaft and connected with the electric motor and a control unit arranged between the electric motor and the torque sensor. In this power steering apparatus, a steering force applied by a driver to the steering wheel is transmitted through the first pinion shaft to the rack shaft and then outputted to vehicle road wheels. On the other hand, the electric motor is driven under the control of the control unit based on a detection signal of the torque sensor so as to output a drive force to the second pinion shaft through the reduction gear and thereby apply a steering assist force to the rack shaft in accordance with the steering force applied to the steering wheel for reduction of driver's steering effort.

### SUMMARY OF THE INVENTION

It is conceivable to modify the dual pinion type power steering apparatus by connecting an additional electric motor to the first pinion shaft in such a manner that the power steering apparatus attains a redundant system equipped with two independently operable motor-driven steering mechanisms. The redundant power steering system enables, in the event of a malfunction in either one of the steering mechanisms, the other steering mechanism to maintain the steering assist function. The above modified dual pinion type power steering apparatus however has a problem that, when one of the rack-and-pinion mechanisms moves into a proper engagement position, there exerts a rotational torsional force from the pinion shaft on the rack shaft in the engaged one of the rack-and-pinion mechanisms so that the other rack-and-pinion mechanism does not move into a proper engagement position under such a torsional force of the rack shaft. This results in a transmission loss of steering assist force.

It is accordingly an object of the present invention to provide a steering control apparatus in which two steering mechanisms are operable independently of each other without causing a transmission loss of steering assist force.

According to a first aspect of the present invention, there is provided a steering control apparatus, comprising: a rack shaft connected to steerable wheels and having rack teeth in a given axial range; a first steering mechanism having a reduction gear and a first electric motor to apply a drive force to the rack shaft through the reduction gear; a second steering mechanism having a second electric motor, a power cylinder equipped with a pair of hydraulic pressure chambers, an oil pump driven by the second electric motor to provide a supply of hydraulic oil to the hydraulic pressure chambers in such a manner that the power cylinder applies a driving force to the rack shaft in accordance with a pressure difference between the hydraulic pressure chambers and a switching unit capable of selectively switching the supply of hydraulic oil from the oil pump to the hydraulic pressure chambers; and a control device that controls the first and second electric motors in response to a driver's steering operation.

According to a second aspect of the present invention, there is provided a steering control apparatus, comprising: a rack shaft connected to steerable wheels and having rack teeth in a given axial range; a pinion shaft connected at one end thereof to a steering wheel via a steering shaft and having pinion teeth at the other end thereof engaged with the rack teeth; a first steering mechanism having a reduction gear and a first electric motor to apply a drive force to the rack shaft through the reduction gear; a second steering mechanism having a second electric motor, a power cylinder equipped with a pair of hydraulic pressure chambers, an oil pump driven by the second electric motor to provide a supply of hydraulic oil to the hydraulic pressure chambers in such a manner that the power cylinder applies a driving force to the rack shaft in accordance with a pressure difference between the hydraulic pressure chambers and a switching unit capable of selectively switching the supply of the hydraulic oil to the hydraulic pressure chambers; and a control device that controls the first and second electric motors in response to a driver's steering operation.

According to a third aspect of the present invention, there is provided a steering control apparatus, comprising: a rack shaft connected to steerable wheels and having rack teeth in a given axial range; a first steering mechanism having a reduction gear and a first electric motor to apply a driving force to the rack shaft through the reduction gear; a second steering mechanism having a second electric motor, a power cylinder equipped with a pair of hydraulic pressure chambers, an oil pump driven by the second electric motor to provide a supply of hydraulic oil to the hydraulic pressure chambers in such a manner that the power cylinder applies a driving force to the rack shaft in accordance with a pressure difference between the hydraulic pressure chambers and a switching unit capable of selectively switching the supply of hydraulic oil from the oil pump to the hydraulic pressure chambers; a first switching circuit that controls a direction of energization of the first electric motor; and a second switching circuit that controls a direction of energization of the second electric motor.

The other objects and features of the present invention will also become understood from the following description.

### BRIEF DESCRIPTION OF THE DRAWINGS

FIG. 1 is a schematic diagram of a steering control apparatus according to a first embodiment of the present invention.

FIG. 2 is a schematic diagram of a steering control apparatus according to a second embodiment of the present invention.

FIG. 3 is a schematic diagram of a steering control apparatus according to a third embodiment of the present invention.

FIG. 4 is a schematic diagram of a steering control apparatus according to a fourth embodiment of the present invention.

FIG. 5 is a schematic diagram of a steering control apparatus according to a fifth embodiment of the present invention.

FIG. 6 is a schematic diagram of a steering control apparatus according to a sixth embodiment of the present invention.

FIG. 7 is a schematic diagram of a steering control apparatus according to a seventh embodiment of the present invention.

FIG. 8 is a schematic diagram of a steering control apparatus according to an eighth embodiment of the present invention.

### DESCRIPTION OF THE EMBODIMENTS

The present invention will be described in detail below by way of the following first to eighth embodiments, in which like parts and portions are designated by like reference numerals to avoid repeated explanations thereof.

### First Embodiment

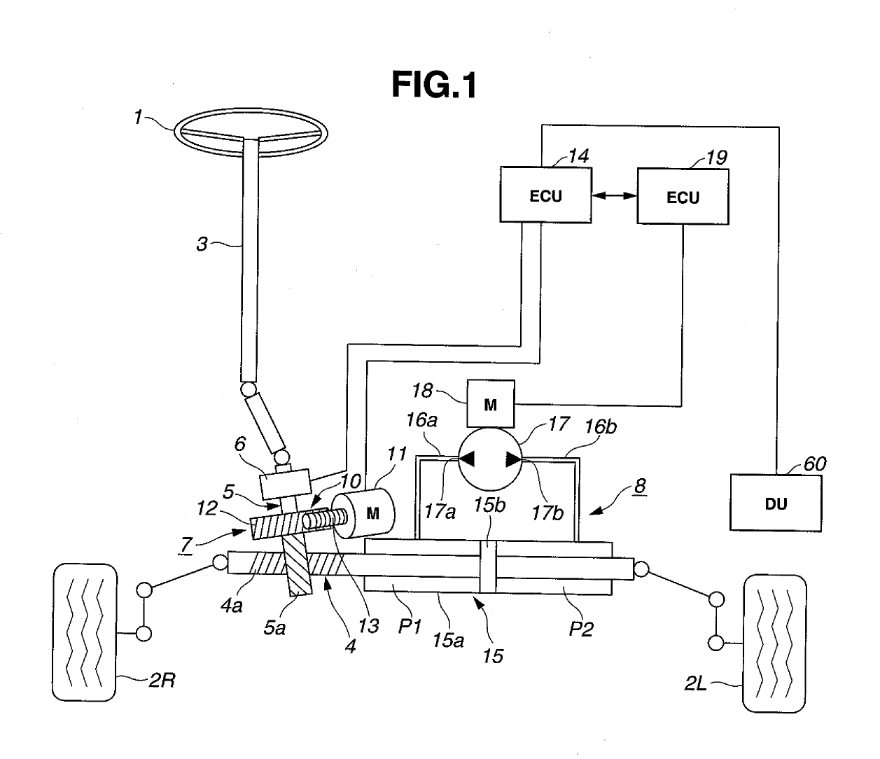

Referring to FIG. 1, a steering control apparatus for an automotive vehicle according to the first embodiment of the present invention is designed as a rack-and-pinion type power steering apparatus that establishes a mechanical link between a steering wheel 1 and steerable road wheels 2L and 2R of the vehicle.

More specifically, the steering control apparatus of the first embodiment includes a steering shaft 3 connected to the steering wheel 1, a rack shaft 4 connected to the vehicle road wheels 2L and 2R and having rack teeth 4a in a given axial range and a pinion shaft 5 having pinion teeth 5a at one end thereof engaged with the rack teeth 4a and connected at the other end to the steering shaft 3 via a torsion bar so as to be rotatable relative to the steering shaft 3. With the application of a steering force to the steering wheel 1 by a vehicle driver, the steering force is transmitted from the steering wheel 1 to the steering shaft 3 so that the steering shaft 3 rotates to cause a twist of the torsion bar. When the pinion shaft 5 rotates relative to the steering shaft 3 under an elastic force of the twisted torsion bar, the steering force is transmitted to the rack shaft 4 through the engagement of the pinion teeth 5a and the rack teeth 4a and then to the vehicle road wheels 2L and 2R. The vehicle road wheels 2L and 2R are thus steered in response to the steering force applied by the vehicle driver.

The steering control apparatus further includes a torque sensor 6, a vehicle driving condition detection unit 60, first and second steering mechanisms 7 and 8, first and second steering force control units 14 and 19.

The torque sensor 6 detects the direction and magnitude of torque (steering force) applied to the steering wheel 1. In the first embodiment, the torque sensor 6 is mounted on the pinion shaft 5 so as to surround an outer periphery of the joint between the steering shaft 3 and the pinion shaft 5 and is configured to detect a rotation direction and torque of the steering shaft 3 and determine the steering direction and torque of the steering wheel 1 based on the detected rotation direction and torque of the steering shaft 3.

The vehicle driving condition detection unit 60 includes a vehicle speed sensor etc. and detects information about the vehicle driving condition such as vehicle traveling speed.

The first steering mechanism 7 has a reduction gear 10 disposed on the pinion shaft 5 and a first steering force generation motor 11 (as a first electric motor) coupled to the pinion shaft 5 via the reduction gear 10 as shown in FIG. 1. In the first embodiment, the reduction gear 10 consists of a worm wheel 12 fitted around an outer periphery of the pinion shaft 5 and a worm shaft 13 coaxially connected to a drive shaft of the first steering force generation motor 11 and engaged with external gear teeth of the worm wheel 12. In order to reduce gear noise caused by the engagement of the worm wheel 12 and the worm shaft 13, the external gear teeth of the worm wheel 12 are formed of a resin material. The first steering force generation motor 11 is driven under the control of the first steering force control unit 14 so as to output a torque to the pinion shaft 5 through the reduction gear 10 and thereby apply an appropriate drive force to the rack shaft 4 through the pinion shaft 5.

The second steering mechanism 8 has a power cylinder 15 disposed on the rack shaft 4 and provided with a pair of hydraulic pressure chambers P1 and P2, a reversible oil pump 17 having a pair of discharge ports 17a and 17b connected to the hydraulic pressure chambers P1 and P2 via pipe lines 16a and 16b, respectively, and a second steering force generation motor 18 (as a second electric motor) coupled to the oil pump 17 as shown in FIG. 1. In the first embodiment, the power cylinder 15 has a cylindrical cylinder tube 15a fitted around an outer periphery of the rack shaft 4 and a piston 15b movably fitted on the outer periphery of the rack shaft 4 so that the inside of the cylinder tube 15a is divided by the piston 15b into the hydraulic pressure chambers P1 and P2. The oil pump 17 provides a selective supply of hydraulic oil to the hydraulic pressure chamber P1, P2 by forward or reverse rotation thereof. The second steering force generation motor 18 is driven under the control of the second steering force control unit 19 so as to rotate to the oil pump 17 in either rotation direction and thereby actuate the power cylinder 15 so that the piston 15b applies an appropriate drive force to the rack shaft 4 according to a pressure difference between the hydraulic pressure chambers P1 and P2.

The first steering force control unit 14 is connected with the first steering force generation motor 11 and with the torque sensor 6 and the vehicle driving condition detection unit 60 and is configured to control the first steering force generation motor 11 based on detection signals of the torque sensor 6 and the vehicle driving condition detection unit 60.

The second steering force control unit 19 is connected with the second steering force generation motor 18 and with the first steering force control unit 14 and is configured to intercommunicate with the first steering force control unit 14 and control the second steering force generation motor 18 based on information from the first steering force control unit 14.

Upon the operation of the steering wheel 1 by the vehicle driver, the first steering force control unit 14 receives the detection signals of the torque sensor 6 and the vehicle driving condition detection unit 60. Then, the first steering force control unit 14 calculates an appropriate steering assist force based on the detection signal of the torque sensor 6 (the steering direction and torque of the steering wheel 1) and generates a motor drive signal to control a driving state of the first steering force generation motor 11 (i.e. the steering assist force applied by the first steering mechanism 7) according to the calculation result. The first steering force generation motor 11 is driven under the motor drive signal from the first steering force control unit 14. The output torque of the first steering force generation motor 11 is exerted as the steering assist force on the pinion shaft 5 so as to assist the steering force applied to the steering wheel 1 and transmitted through the steering shaft 3 to the pinion shaft 5.

On the other hand, the second steering force control unit 19 receives the information from the first steering force control unit 14 including the detection signals of the torque sensor 6 and the vehicle driving condition detection unit 60 and the motor drive signal of the first steering force control unit 14, and then, judges whether the vehicle requires an additional steering assist force other than the steering assist force applied by the first steering mechanism 7 based on the information from the first steering force control unit 14. When the vehicle is judged as requiring the additional steering assist force, the second steering force control unit 19 calculates an appropriate additional steering assist force based on the information from the first steering force control unit 14 and generates a motor drive signal to control a driving state of the second steering force generation motor 18 (i.e. the steering assist force applied by the second steering mechanism 8) according to the calculation result. Namely, the second steering mechanism 8 is not always actuated in response to the driver's steering operation in a state where the first steering mechanism 8 is functioning properly. The second steering mechanism 8 is stopped when the vehicle does not require a large steering assist e.g. during high-speed driving and is operated as an auxiliary steering assist unit when the vehicle requires a large steering assist e.g. during low-speed driving. The second steering force generation motor 18 is driven under the motor drive signal from the second steering force control unit 19 to change the rotation direction of the oil pump 17 and actuate the power cylinder 15 by the selective hydraulic oil supply from the oil pump 17 to the hydraulic pressure chamber P1, P2. The output of the power cylinder 15 (piston 15b) is exerted as the additional steering assist force on the rack shaft 4 so as to assist the steering force applied from the pinion shaft 5 to the rack shaft 4 (i.e., the resultant of the steering force applied to the steering wheel 1 and transmitted through the steering shaft 3 to the pinion shaft 5 and the steering assist force applied to the pinion shaft 5 by the first steering mechanism 7).

Herein, the rotation direction of the second steering force generation motor 18 is controlled to change the rotation direction of the oil pump 17 and thereby switch the hydraulic oil supply to the hydraulic pressure chamber P1, P2 according to the detection signal of the torque sensor 6 (notably, the steering direction of the steering wheel 1). The torque sensor 6 thus serves as not only a steering sensor but also a switching unit that switches the hydraulic oil supply to the hydraulic pressure chambers P1 and P2 in the first embodiment.

In this way, the steering control apparatus are equipped with the two independently operable steering mechanisms 7 and 8. In the event of a malfunction in either one of the steering mechanisms 7 and 8, the steering control apparatus allows the other of the steering mechanisms 7 and 8 to apply the steering assist force and assist the driver's steering operation. It is therefore possible to avoid the risk of compromising the integrity of the steering assist function of the steering control apparatus even in the event the malfunction occurs in either of the steering mechanisms 7 and 8. Further, the steering control apparatus causes the first steering force control unit 14 to stop the first steering force generation motor 11 in the event of the malfunction in the first steering mechanism 7 and causes the second steering force control unit 19 to stop the second steering force generation motor 18 in the event of the malfunction in the second steering mechanism 8. It is thus possible to avoid abnormal actuation and excess power consumption of the steering force generation motor 11, 18 in the malfunctioning steering mechanism 7, 8. In the event of malfunctions in both of the steering mechanisms 7 and 8, the steering control apparatus stops both the steering mechanisms 7 and 8. Even in this case, there is no danger that the vehicle becomes out of control since the steering control apparatus maintains the mechanical link between the steering wheel 1 and the vehicle road wheels 2L and 2R.

In addition, the steering control apparatus utilizes the hydraulic steering mechanism 8 in which the power cylinder 15 (the piston 15b) applies the drive force as the steering assist force to the rack shaft 4 according to the pressure difference between the hydraulic pressure chambers P1 and P2 as explained above. The operation of such a hydraulic steering mechanism 8 does not cause a torsion of the rack shaft 4 that interferes with the engagement of the rack shaft 4 and the pinion shaft 5. There is no possibility that the engagement of the rack shaft 4 and the pinion shaft 5 is subjected to extra load due to the torsion of the rack shaft 4. This makes it possible to prevent a transmission loss of the steering force between the pinion shaft 5 and the rack shaft 4 and avoid a deterioration in durability of the rack-and-pinion mechanism 5 and 4.

In the first embodiment, the steering control apparatus adopts a so-called pinion assist type power steering system in which the first steering mechanism 7 is disposed on the pinion shaft 5 as explained above. The adoption of the pinion assist type power steering system makes it possible to secure a higher strength and apply a larger steering force as compared to the case of a so-called column assist type power steering system in which the first steering mechanism 7 is disposed on a steering column in view of the fact that the steering column has a great design restriction in terms of space etc. (See the second embodiment.) The adoption of the pinion assist type power steering system also makes it possible that the first steering mechanism 7 can be made compact in size in the vehicle length direction to allow a size reduction of the steering control apparatus as compared to the case of a so-called rack assist power steering system in which the first steering mechanism 7 is disposed on the rack shaft 4 in view of the fact that the power cylinder 15 is located on an outer peripheral side of the rack shaft 4 to cause an increase in apparatus size in the rack assist power steering system. (See the third embodiment.)

Furthermore, the second steering mechanism 8 is provided with a closed hydraulic circuit so as to enable the flow of the hydraulic oil from one of the hydraulic pressure chambers P1 and P2 to the other of the hydraulic pressure chambers P1 and P2 of the power cylinder 15 in the first embodiment. This produces a higher energy-saving effect as compared to the case where the second steering mechanism 8 is provided with an open hydraulic circuit (the oil pump is driven all the time even during straight driving to drain excessive hydraulic oil).

### Second Embodiment

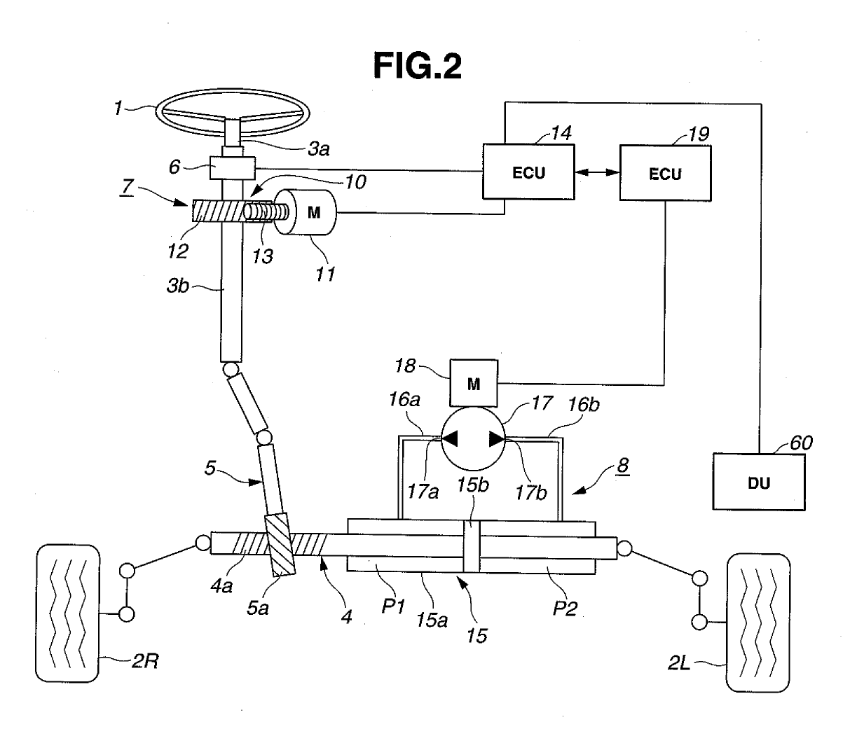

A steering control apparatus of the second embodiment is structurally similar to that of the first embodiment, except that: the steering control apparatus utilizes a steering column assembly and adopts a column assist type power steering system as shown in FIG. 2

The steering column assembly is connected to the pinion shaft 5 so that the steering shaft 3a and the pinion shaft 5 can rotate together with each other. As shown in FIG. 2, this steering column assembly has a steering shaft 3a connected to the steering wheel 1 and a steering column 3b rotatable relative to the steering shaft 3a. The steering shaft 3a and the steering column 3b are coupled together via a torsion bar.

The torque sensor 6 is disposed on the steering column 3b so as to surround an outer periphery of the joint between the steering shaft 3a and the steering column 3b.

The first steering mechanism 7 is disposed around the steering column 7 rather than around the pinion shaft 5. More specifically, the reduction gear 10 is fitted around an outer periphery of the steering column 3b. The first steering force generation motor 11 is coupled to the steering column 3b via the reduction gear 10 so that the output torque of the first steering force generation motor 11 is applied as the steering assist force through the steering column 3b to the pinion shaft 5.

As explained above, the steering control apparatus of the second embodiment has the same structure as that of the first embodiment except for the type of the power steering system (i.e. the placement of the torque sensor 6 and the second steering mechanism 7). It is thus possible in the second embodiment to obtain the same effects as those in the first embodiment. Further, the adoption of the column assist type power steering system makes it possible that the torque sensor 6 and the first steering mechanism 7 can be arranged in the vehicle interior. This eliminates the need to take measures for water proofing of the torque sensor 6 and the first steering mechanism 7 and attains reductions in manufacturing cost and effort and parts count of the steering control apparatus.

### Third Embodiment

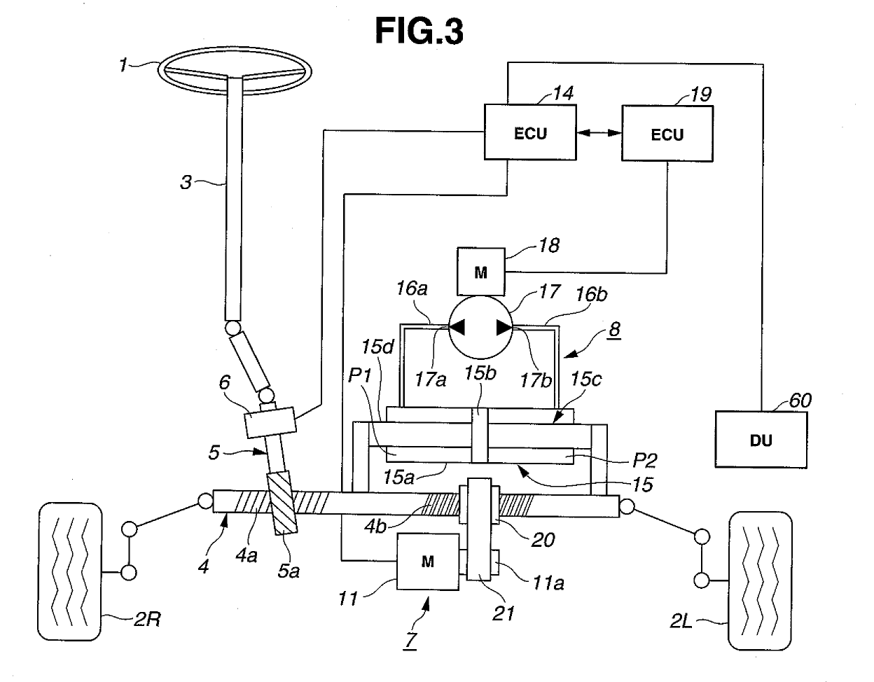

A steering control apparatus of the third embodiment is structurally similar to that of the first embodiment, except that the steering control apparatus adopts a rack assist type power steering system as shown in FIG. 3.

The rack shaft 4 has a ball screw portion 4b formed in a different axial range from the rack teeth 4a.

The first and second steering mechanisms 7 and 8 are disposed on opposite sides of the rack shaft 4 in parallel with each other.

In the first steering mechanism 7, the reduction gear 10 has a ball nut 20 movably engaged on the ball screw portion 14b of the rack shaft 14 and a belt 21 looped around the ball nut 20 and the drive shaft 11a of the first steering force generation motor 11 so as to, when the first steering force generation motor 11 is driven under the control of the first steering force control unit 14, transmit the torque of the first steering force generation motor 11 to the ball nut 20 and thereby rotate the ball nut 20 around the ball screw portion 4b. The rotation of the ball nut 20 is converted to an axially linear motion of the rack shaft 4 by the engagement of the ball nut 20 and the ball screw portion 4b so as to assist the steering force applied to the steering wheel 1 and transmitted from the pinion shaft 5 to the rack shaft 4.

In the second steering mechanism 8, by contrast, the power cylinder 15 has a piston rod 15c integrally connected to the rack shaft 4 in a bridge manner that the ball screw portion 4b is located between the points of bridge connection of the rack shaft 4 and the piston rod 15c. Herein, the piston rod 15c is formed separately from the rack shaft 4 and joined by any joining means such as welding to the rack shaft 4. The piston rod 15c includes a cylinder shaft 15d extending adjacent to and in parallel with the rack shaft 4. The piston 15b is fitted around the cylinder shaft 15d rather than around the rack shaft 4. When the second steering force control unit 19 judges based on the information from the first steering force control unit 14 that the vehicle requires an additional steering assist force other than the steering assist force applied by the first steering mechanism 7, the second steering force generation motor 18 is driven under the control of the second steering force control unit 19 to operate the oil pump 17 and actuate the power cylinder 15. The power cylinder 15 causes a movement of the piston 15b in response to the pressure difference between the hydraulic pressure chambers P1 and P2. The movement of the piston 15b is inputted to the rack shaft 4 through the piston rod 15c so as to assist the steering force transmitted from the pinion shaft 5 to the rack shaft 4.

It is thus possible in the third embodiment to obtain the same effects as those in the first embodiment as the steering control apparatus of the third embodiment has the same structure as that of the first embodiment except for the type of the power steering system (the placement of the first steering mechanism 7). As the rack shaft 4 has almost no design restriction differently from the pinion shaft 5 and the steering column 3b, the adoption of the rack assist type power steering system makes it possible to secure a higher strength and apply a larger steering force as compared to the case of the pinion assist type or column assist type power steering system. Further, the parallel arrangement of the rack shaft 4 and the power cylinder 15 allows a reduction in the size of the steering control apparatus in the vehicle width direction as compared to the serial arrangement of the rack shaft 4 and the power cylinder 15. In other words, the size of the steering control apparatus in the vehicle lateral width can be maintained the same as that of the conventional type. This makes it possible to prevent the moutablity and versatility of the steering control apparatus from being deteriorated due to increase in apparatus size.

### Fourth Embodiment

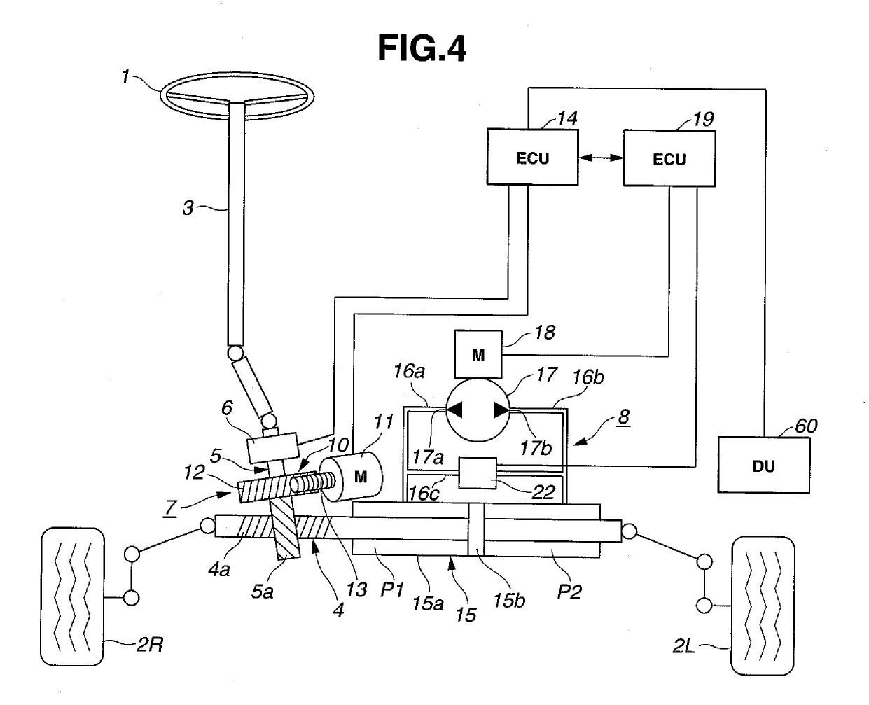

A steering control apparatus of the fourth embodiment is structurally similar to that of the first embodiment, except that the second steering mechanism 8 has a communication line 16c equipped with a so-called fail-safe valve 22 as shown in FIG. 4.

The communication line 16c is arranged between the pipe lines 16a and 16b so that the hydraulic pressure chambers P1 and P2 are in direct communication with each other through the communication line 16c.

The fail-safe valve 22 is arranged at a midpoint in the communication line 16c and is opened under the control of the second steering force control unit 19 to establish a communication between the hydraulic pressure chambers P1 and P2 in case of an emergency e.g. in the event of a malfunction in the second steering force generation motor 18.

As explained above, the steering control apparatus of the fourth embodiment has the same structure as that of the first embodiment except for the configuration of the second steering mechanism 8. It is thus possible in the fourth embodiment to obtain the same effects as those in the first embodiment. Further, the fail-safe valve 22 is provided to open or close the communication line 16 between the hydraulic pressure chambers P1 and P2 in the second steering mechanism 8. In the event the malfunction occurs in the second steering mechanism 8, the fail-safe valve 22 opens the communication line 16 between the hydraulic pressure chambers P1 and P2 and thereby allows the most part of the hydraulic oil to flow between the hydraulic pressure chambers P1 and P2 without passing through the oil pump 17. This makes it possible to prevent the influence of the inertia of the oil pump 17 and to reduce flow resistance of the hydraulic oil for the smooth flow of the hydraulic oil between the hydraulic pressure chambers P1 and P2.

### Fifth Embodiment

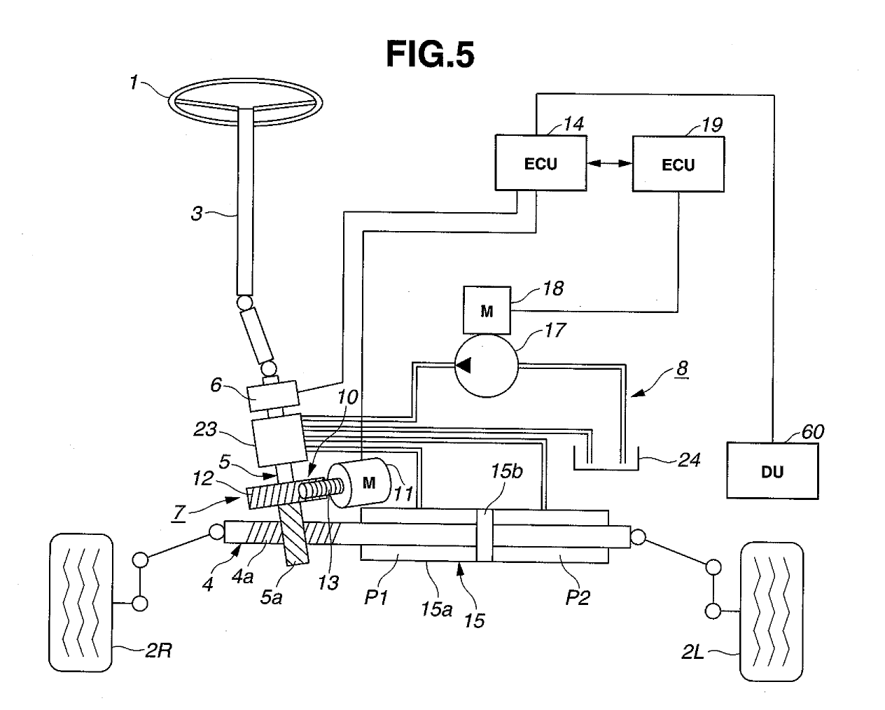

A steering control apparatus of the fifth embodiment is structurally similar to that of the first embodiment, except that: the oil pump 17 is a one-way pump rather than a two-way pump; and the switching unit is a rotary valve 23 capable of selectively switching the hydraulic oil supply from the oil pump 17 to the hydraulic pressure chamber P1, P2 as shown in FIG. 5.

The oil pump 17 has a suction port connected to an oil reservoir tank 24 and a discharge port connected to the hydraulic pressure chamber P1, P2.

There is no particular restriction on the rotary valve 23. The rotary valve 23 can be of known type as disclosed in Japanese Laid-Open Patent Publication No. 5-42880. The rotary valve 23 is located in the overlap portion between the connection ends of the steering shaft 3 and the pinion shaft 5. When the second steering force generation motor 18 is driven under the control of the second steering force control unit 19 upon judging that the vehicle requires an additional steering assist force, the rotary valve 23 is operated to bring one of the hydraulic pressure chambers P1 and P2 into communication with the discharge port of the oil pump 17 and the other of the hydraulic pressure chambers P1 and P2 with the oil reservoir tank 24 according to the detection signal of the torque sensor 6 (the steering direction of the steering wheel 1). The opening amount of the rotary valve 23 is varied depending on the steering torque of the steering wheel 1, i.e., the amount of relative rotation of the steering shaft 3 and the pinion shaft 5, thereby adjusting the amount of the hydraulic oil supplied to the hydraulic pressure chamber P1, P2. The power cylinder 15 causes a movement of the piston 15b in response to the pressure difference between the hydraulic pressure chambers P1 and P2. The movement of the piston 15b is inputted to the rack shaft 4 through the piston rod 15c so as to assist the steering force applied from the pinion shaft 5 to the rack shaft 4.

It is thus possible in the fifth embodiment to obtain the same effects as those in the first embodiment as the steering control apparatus of the fifth embodiment has the same structure as that of the first embodiment except for the structures of the switching unit and the oil pump 17. In the fifth embodiment, the rotary valve 23 is used to switch the hydraulic oil supply to the hydraulic pressure chamber P1, P2 in accordance with the driver's steering operation. The use of such a rotary valve 23 enables a more direct application of the steering assist force and improves the driver's steering feeling.

### Sixth Embodiment

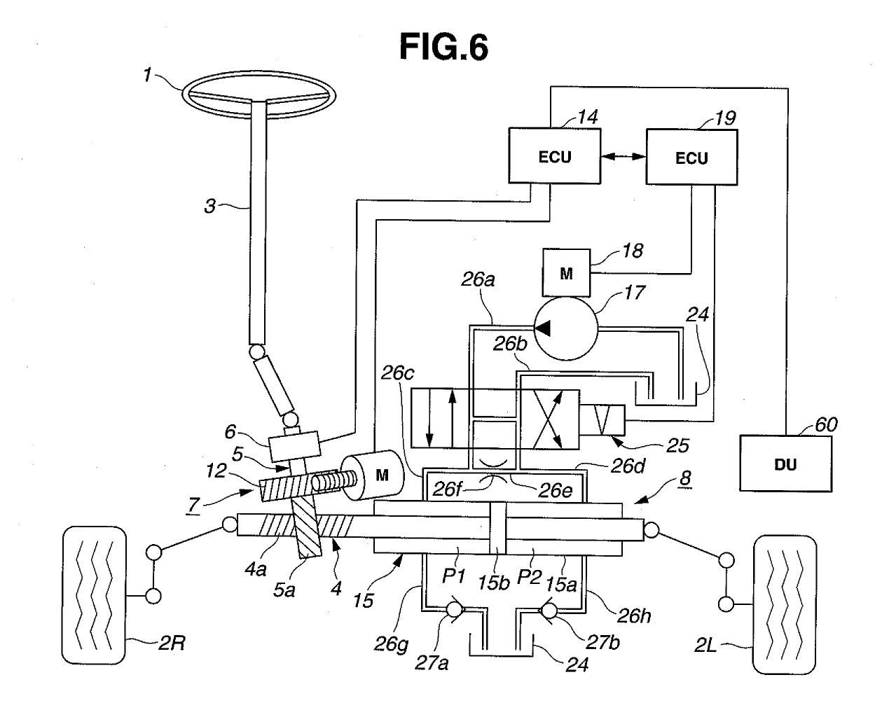

A steering control apparatus of the sixth embodiment is structurally similar to that of the fifth embodiment, except that a solenoid valve 25 is used as the switching unit in place of the rotary valve 23 as shown in FIG. 6.

The solenoid valve 25 has a four-port three-position valve structure in the sixth embodiment. More specifically, the solenoid valve 25 has a first port connected to the oil pump 17 through a pipe line 26a, a second port connected to the oil reservoir tank 24 through a pipe line 26b and third and fourth ports connected to the hydraulic pressure chambers P1 and P2 through pipe lines 26c and 26d, respectively. The solenoid valve 25 is operated under the control of the second steering force control unit 19 according to the detection signal of the torque sensor 6. When either coil of the solenoid valve 25 is energized in accordance with the steering direction of the steering wheel 1, a spool of the solenoid valve 25 is moved axially to establish a communication from the pipe line 26a to one of the pipe lines 26c and 26d and a communication from the other of the pipe lines 26c and 26d to the pipe line 26b. In the case of left turning, for example, the solenoid valve 25 allows communications between the pipe lines 26a and 26c and between the pipe lines 26b and 26d so as to introduce the hydraulic oil from the oil pump 17 into the hydraulic pressure chamber P1 and return the hydraulic oil from the hydraulic pressure chamber P2 to the oil reservoir tank 24. If the hydraulic oil is discharged excessively from the oil pump 17, the solenoid valve 25 is switched to return the excessive hydraulic oil to the oil reservoir tank 24.

The second steering mechanism 8 has a communication line 26e between the pipe lines 26c and 26d. The communication line 26 is equipped with a throttle 26f so as to, when any impact is inputted from the road to the vehicle road wheels 2L and 2R in a direction that turns the vehicle road wheels 2L and 2R during driving, damp pressure caused by such impact and absorb the impact from the road. The second steering mechanism 8 also has pipe lines 26g and 26h through which the hydraulic pressure chambers P1 and P2 are connected to the oil reservoir tank 24 for volume compensation of the hydraulic pressure chambers P1 and P2. These pipe lines 26g and 26h are provided separately from the pipe lines 26c and 26d and equipped with check valves 27a and 27b to prevent backflow of the hydraulic oil from the hydraulic pressure chambers P1 and P2 to the reservoir tank 24.

It is thus possible in the sixth embodiment to obtain the same effects as those in the fifth embodiment as the steering control apparatus of the sixth embodiment has the same structure as that of the fifth embodiment except for the structure of the switching unit. In the sixth embodiment, the solenoid valve 25 is provided to switch the supply and drain of the hydraulic oil to and from the hydraulic pressure chambers P1 and P2. The use of such a solenoid valve 25 makes it possible to control the second steering mechanism 8 more accurately, even without securing a high level of control accuracy for the second steering force generation motor 18, and thereby allows a manufacturing cost reduction of the steering control apparatus. Further, the solenoid valve 25 can be switched to communicate with the oil reservoir tank 24. This makes it possible to return the excessive hydraulic oil to the oil reservoir tank 24 and prevent the excessive hydraulic oil from being supplied to the hydraulic pressure chamber P1, P2.

### Seventh Embodiment

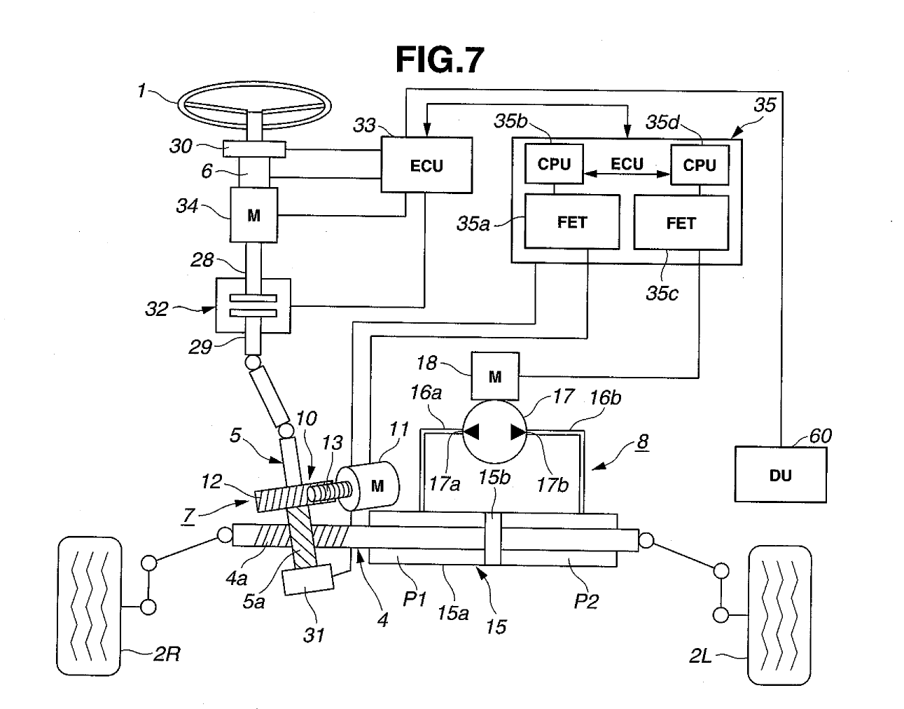

A steering control apparatus of the seventh embodiment is structurally similar to that of the first embodiment, except that the steering control apparatus adopts a steer-by-wire system that allows the vehicle to be steered electronically without a direct mechanical link between the steering wheel 1 and the vehicle road wheels 2L and 2R as shown in FIG. 7.

More specifically, the steering control apparatus of the seventh embodiment includes a first steering shaft 28 connected to the steering wheel 1, a rack shaft 4 connected to the vehicle road wheels 2L and 2R and having rack teeth 4a, a pinion shaft 5 having pinion teeth 5a engaged with the rack teeth 4a, a second steering shaft 29 connected at one end thereof to the first steering shaft 28 and at the other end to the pinion shaft 5, a clutch 32 arranged between the first and second steering shaft 28 and 29, a first steering mechanism 7 coupled to the pinion shaft 5 and a second steering mechanism 8 coupled to the rack shaft 4.

Herein, the first and second steering mechanisms 7 and 8 of the seventh embodiment are the same in structure as those of the first embodiment. In the first steering mechanism 7, the first steering force generation motor 11 is driven to output a torque to the pinion shaft 5 through the reduction gear 10 and thereby apply an appropriate drive force to the rack shaft 4 through the pinion shaft 5. In the second steering mechanism 8, the second steering force generation motor 18 is driven to operate the oil pump 17 and thereby selectively supply the hydraulic oil to the hydraulic pressure chambers P1 and P2 so that the power cylinder 15 outputs an appropriate drive force to the rack shaft 4 in response to the pressure difference between the hydraulic pressure chambers P1 and P2.

The clutch 32 is operated as a fail-safe unit under the control of the reaction force control device 33 to connect and disconnect the first and second steering shafts 28 and 29 according to the operation states of the first and second steering mechanisms 7 and 8. In a normal condition where both of the first and second steering mechanisms 7 and 8 function properly, the clutch 32 is disengaged to disconnect the first and second steering shafts 28 and 29. As the steering force applied to the steering wheel 1 is not transmitted from the first steering shaft 28 to the second steering shaft 29 during disengagement of the clutch 32, the output of the first steering force generation motor 11 is exerted as a steering force on the rack shaft 4 through the pinion shaft 5. The clutch 32 is engaged to connect the first and second steering shafts 28 and 29 in an abnormal condition where a malfunction occurs in at least one of the first and second steering mechanisms 7 and 8. As the steering force applied to the steering wheel 1 is directly transmitted from the first steering shaft 28 to the second steering shaft 29, then to the pinion shaft 5 and then to the rack shaft 4 during engagement of the clutch 32, the output of the first steering force generation motor 11 is exerted as a steering assist force on the rack shaft 4 through the pinion shaft 5.

The steering control apparatus of the seventh embodiment further includes a torque sensor 6, a steering angle sensor 30, a steered angle sensor 31, a reaction force generation motor 34, a reaction force control device 33, a steering force control device 35 and a vehicle driving condition detection unit 60 such as a vehicle speed sensor.

The torque sensor 6 is disposed on the first steering shaft 28 and configured to detect a steering torque of the steering wheel 1.

The steering angle sensor 30 is also disposed on the first steering shaft 28 and is configured to measure a rotation angle of the first steering shaft 28 and detect a steering angle of the steering wheel 1 based on the measured steering shaft rotation angle.

The steered angle sensor 31 is disposed on a front end of the pinion shaft 5 on an opposite side of the pinion shaft 5a from the reduction gear 10 and configured to measure a rotation angle of the pinion shaft 5 from the radial direction and detect an actual steered angle of the vehicle road wheels 2L and 2R based on the measured pinion shaft rotation angle. The configuration of the steered angle sensor 31 is not limited to the above. The steered angle sensor 31 may alternatively be configured to measure the rotation angle of the pinion shaft 5 from the thrust direction and detect the actual steered angle of the vehicle road wheels 2L and 2R based on the measured pinion shaft rotation angle, or be configured to detect the actual steered angle of the vehicle road wheels 2L and 2R based on the movement amount of the rack shaft 4.

The reaction force generation motor 34 is coupled to the first steering shaft 28 via a reduction gear and is driven to artificially apply a so-called steering reaction force, which corresponds to the input from the road to the vehicle road wheels 2L and 2R, through the steering shaft 28 to the steering wheel 1 in response to the steering operation under the normal condition (in which the clutch 32 is disengaged). With the application of such an artificial steering reaction force, the steer-by-wire electronic steering control system can provide the same steering feeling to the driver as that of the above ordinary mechanical steering control system.

The reaction force control device 33 is connected with the reaction force generation motor 34, with the torque sensor 6, the steering angle sensor 30 and the vehicle driving condition detection unit 60 and with the steering force control device 35 and is configured to intercommunicate with the steering force control device 35 and control a driving state of the reaction force generation motor 34 based on detection signals of the torque sensor 6, the steering angle sensor 30 and the vehicle driving condition detection unit 60.

The steering force control device 35 is connected with the first and second steering force generation motors 11 and 18, with the steered angle sensor 31 and with the reaction force control device 33 and is configured to intercommunicate with the reaction force control device 33 and control the drive states of the first and second steering force generation motors 11 and 18 based on a detection signal of the steered angle sensor 31 and information from the reaction force control device 33.

As shown in FIG. 7, the steering force control device 35 has a first switching circuit 35a connected to the first steering force generation motor 11 to switch the direction of energization, i.e., the rotation direction of the first steering force generation motor 11, a first motor command calculation circuit 35b connected to the first switching circuit 35a to calculate and output a command for controlling the amount of energization of the first steering force generation motor 11, a second switching circuit 35c connected to the second steering force generation motor 18 to switch the direction of energization, i.e., the rotation direction of the second steering force generation motor 18 and a second motor command calculation circuit 35d connected to the second switching circuit 35c to calculate and output a command for controlling the amount of energization of the second steering force generation motor 18. It can be thus defined that the first switching circuit 35a and the first motor calculation circuit 35b form a first steering force control unit for controlling the drive state of the first steering force generation motor 11; and the second switching circuit 35c and the second motor calculation circuit 35d form a second steering force control unit for controlling the drive state of the second steering force generation motor 18. In the seventh embodiment, the switching circuits 35a and 35c are comprised of FET (field-effect transistor) drivers. The motor command calculation circuits 35b and 35d are comprised of main CPUs (central processing units) and are allowed to monitor each other to check the occurrence of any failure in the steering control apparatus. The switching circuits 35a and 35c and the motor command calculation circuits 35b and 35d are accommodated in a single casing.

Under the normal condition, the clutch 32 is disengaged so as not to allow transmission of the steering force from the steering wheel 1 to the rack shaft 4 through the steering shafts 28 and 29 and through the pinion shaft 5. When the steering wheel 1 is operated in such a normal condition, the steering force control device 35 receives the detection signals of the steering angle sensor 30, the steered angle sensor 31 and the vehicle driving condition detection unit 60 etc. through the reaction force control device 33. The first motor command calculation circuit 35b calculates the command to control the energization amount of the first steering torque generation motor 11 based on the detection signals of the steering angle sensor 30 and the steered angle sensor 31 and outputs the motor control command through the switching circuit 35a to the first steering torque generation motor 11. The first steering torque generation motor 11 is driven under the motor control command from the first steering force control unit. The output of the first steering force generation motor 11 is transmitted to the pinion shaft 5 through the reduction gear 10 and then exerted from the pinion shaft 5 to the rack shaft 4 to steer the vehicle road wheels 2L and 2R according to the steering angle of the steering wheel 1. Also, the second motor command calculation circuit 35d calculates the command to control the energization amount of the second steering force generation motor 18 based on the detection signal of the steering angle sensor 30 and the motor control command from the first motor command calculation circuit 35b and outputs the motor control command through the switching circuit 35c to the second steering torque generation motor 18. The second steering torque generation motor 18 is driven under the motor control command from the second steering force control unit to operate the oil pump 17 and thereby actuate the power cylinder 15. The output of the power cylinder 15 (piston 15b) is exerted on the rack shaft 4 as a steering assist force to assist the steering force applied by the first steering mechanism 7. On the other hand, the reaction force control device 33 receives the detection signals of the steering angle sensor 30, the torque sensor 6 and the vehicle speed sensor 60 and the calculation results of the steering force control device 35 (first and second motor command calculation circuits 35b and 35d) etc. and drives the reaction force generation motor 34 according to the detection signals of the steering angle sensor 30, the torque sensor 6 and the vehicle speed sensor 60 and the calculation results of the steering force control device 35. The output of the reaction force generation motor 34 is applied to the first steering shaft 28 and then to the steering wheel 1 as the steering reaction force. The vehicle is thus steered by electric control without a mechanical link between the steering wheel 1 and the vehicle road wheels 2L and 2R.

In the above electronic steering control operation, the output of the first steering mechanism 7 (the amount of rotation of the pinion shaft 5) is no always held consistent with the steering input (the amount of steering operation of the steering wheel 1). The steering force control device 35 sets the steering output of the first steering mechanism 7 small relative to the steering input of the steering wheel 1 in a state where the vehicle does not require a large steering amount e.g. during high-speed driving (i.e. the large steering amount results in a danger) and sets the steering output of the first steering mechanism 7 large relative to the steering input of the steering wheel 1 in a state where the vehicle requires a large steering amount e.g. during parking. Moreover, the second steering mechanism 8 does not always become actuated in response to the driver's steering operation in a state where the first steering mechanism 8 functions properly. The second steering mechanism 8 is stopped when the vehicle does not require a large steering assist e.g. during high-speed driving and is operated to perform the steering assist function properly when the vehicle requires a large steering assist e.g. during low-speed driving.

Under the abnormal condition where the malfunction occurs in at least one of the steering mechanisms 7 and 8, by contrast, the clutch 32 is engaged to connect the steering shafts 28 and 29 and thereby allow transmission of the steering force from the steering wheel 1 to the rack shaft 4 through the steering shafts 28 and 29 and through the pinion shaft 5. The vehicle is thus steered directly in response to the driver's steering operation so as to secure driving safety. Further, the first steering mechanism 7 is operated under the control of the first steering force control unit in the occurrence of the malfunction in the second steering mechanism 8 so that the output of the first steering force generation motor 11 is exerted from the pinion shaft 5 on the rack shaft 4 to assist the steering force applied to the steering wheel 1 and transmitted to the rack shaft 4 through the steering shafts 28 and 29 and through the pinion shaft 5. In the occurrence of the malfunction in the first steering mechanism 7, the second steering mechanism 8 is operated under the control of the second steering force control unit so that the output of the power cylinder 15 is exerted on the rack shaft 4 to assist the steering force applied to the steering wheel 1 and transmitted through the steering shafts 28 and 29 and through the pinion shaft 5 to the rack shaft 4. Namely, the steering control apparatus allows, in the event of the malfunction in either one of the steering mechanisms 7 and 8, the other steering mechanism 7, 8 to maintain the steering assist function. As the clutch 32 is engaged in the occurrence of the malfunction in at least one of the steering mechanisms 7 and 8 rather than in the occurrence of malfunctions in both of the steering mechanisms 7 and 8, there is no danger that, even in the case where the malfunctions occurs successively in the respective steering mechanisms 7 and 8, the vehicle becomes out of control during a lapse of time from the later occurrence of the malfunction in the steering mechanism 7, 8 to the engagement of the clutch 32.

As explained above, it is possible in the seventh embodiment to obtain the same effects as those in the first embodiment. Furthermore, the adoption of the steer-by-wire system makes it possible that the power steering apparatus can perform free and appropriate steering control according to the vehicle driving condition and environment, without being restricted by the driver's steering operation, by varying the steering output (the steered amount of the vehicle road wheels 2L and 2R) relative to the steering input (the steering amount of the steering wheel 1) depending on the vehicle driving condition and environment during e.g. high-speed driving or parking.

In the steering force control device 35, the first and second motor control units are provided separately from and independently of each other to control the first and second steering force generation motors 11 and 18, respectively. In the event of the malfunction in either one of the switching circuits 35a and 35c or in either one of the motor command calculation circuits 35b and 35d, the steering force control device 35 allows the other to drive the corresponding steering mechanism 7, 8 so that the steering control apparatus can perform steering control operation continuously. As it is very unlikely that malfunctions will occurs in both of the switching circuits 35a and 35c or in both of the motor command calculation circuits 35b and 35d, there is no danger that the steering control operation of the steering control apparatus becomes disabled. In addition, the steering force control device 35 enables an early and assured detection of any failure in the steering control apparatus by mutual monitoring between the motor command calculation circuits 35b and 35d. There is no need to provide an additional, separate failure occurrence monitoring unit in the steering force control device 35. This makes it possible to improve the reliability and safety of the steering control apparatus and achieve structure simplification and manufacturing cost reduction of the steering control apparatus. It is however conceivable to provide an additional separate monitoring unit(s) for more accurate and assured detection of the failure in the steering control apparatus.

In the seventh embodiment, the steered angle sensor 31 is located on the front end of the pinion shaft 5a opposite from the reduction gear 10. The arrangement design flexibility of the steered angle sensor 31 can be thus improved by preventing interference between the steered angle sensor 31 and the reduction gear 10. The steered angle sensor 31 can be made compact in size when configured to detect the steered angle of the vehicle road wheels 2L and 2R) from the thrust direction with respect to the pinion shaft 5.

### Eighth Embodiment

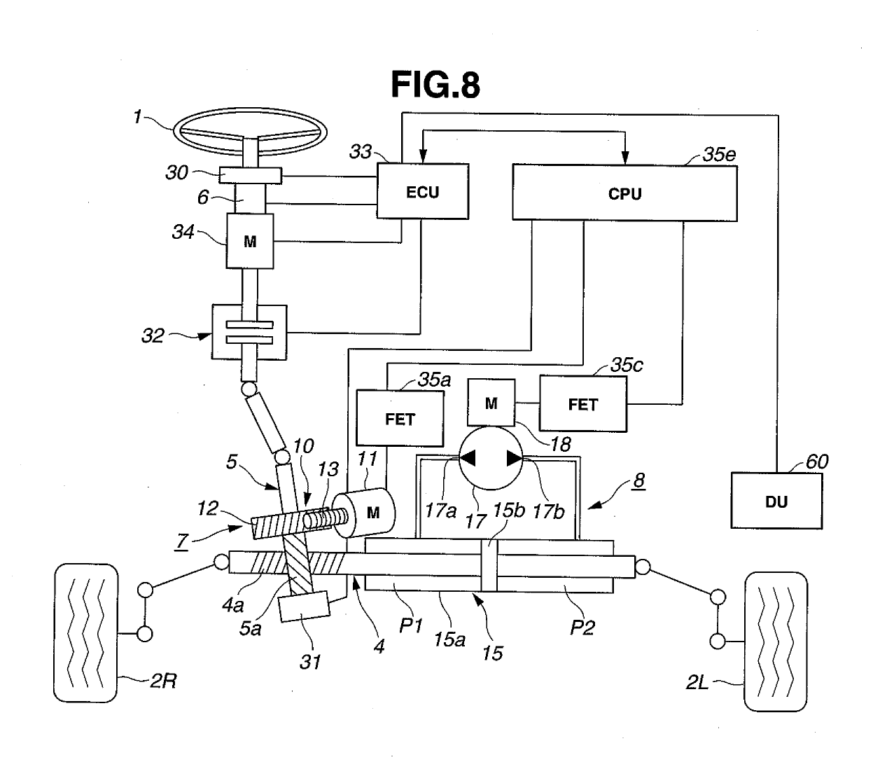

A steering control apparatus of the eighth embodiment is structurally similar to that of the seventh embodiment, except that the steering force control device 35 has a single main CPU, rather than two main CPUs, as a motor command calculation circuit 35e separately from and independently of the first and second switching circuit 35a and 35c as shown in FIG. 8.

The motor control command calculation circuit 35e is arranged in a space in e.g. an engine room of the vehicle and is configured to calculate and output a command for controlling the energization amount of each of the first and second steering force generation motors 11 and 18.

The first and second switching circuit 35a and 35c are arranged adjacent to the first and second steering force generation motors 11 and 18, respectively, and connected with the motor control command calculation circuit 35e by wire cables so that each of the first and second switching circuit 35a and 35c switches the corresponding steering force generation motor 11, 18 under the motor control command from the first steering force control unit.

It is therefore possible in the eighth embodiment to obtain the same effects as in the seventh embodiment. In the eighth embodiment, the motor command calculation circuit 35e is provided as a single CPU that integrates therein the first and second motor control units. The use of such a single, integrated calculation circuit 35e allows structure simplification and manufacturing cost reduction of the steering control apparatus. Further, the motor command calculation circuit 35e is provided separately from the switching circuits 35a and 35c. The switching circuits 35a and 35c can be thus arranged adjacent to the first and second steering force generation motors 11 and 18, respectively, so as to shorten the connection wiring between the switching circuit 35a and the first steering force generation motor 11 and between the switching circuit 35c and the second steering force generation motor 18 and thereby minimize the loss of energization power supplied to the steering force generation motor 11, 18 through the switching circuit 35a, 35c. The motor command calculation circuit 35e can be arranged in the engine room so as to make the most effective use of the empty space in the engine room for improvement in in vehicle layout flexibility.

The entire contents of Japanese Patent Application No. 2008-319188 (filed on Dec. 16, 2008) are herein incorporated by reference.

Although the present invention has been described with reference to the above-specific embodiments of the invention, the invention is not limited to these exemplary embodiments. Various modification and variation of the embodiments described above will occur to those skilled in the art in light of the above teachings. For example, the operation controls of the first and second steering mechanisms 7 and 8 can be modified as appropriate depending on the specifications of the vehicle to which the steering control apparatus is applied. Although the first and second steering force control units 14 and 19 are provided as separate independent electronic control units in the first to sixth embodiments, these control units 14 and 19 may be integrated into one unit for structure simplification and manufacturing cost reduction of the steering control apparatus. Although the steering angle sensor 31 is disposed on the front end side of the pinion shaft 5 in the seventh and eighth embodiments, the steering angle sensor 31 may alternatively be disposed on the base end side of the pinion shaft 5 such that the steering angle sensor 31 and the reduction gear 10 are arranged protrudingly on the same one side of the pinion shaft 5 with respect to the pinion gear 5a so as to minimize the range of increase in size around the pinion shaft 5. The scope of the invention is defined with reference to the following claims.

What is claimed is:

1. A steering control apparatus, comprising:
a rack shaft connected to steerable wheels and having rack teeth in a given axial range;
a first steering mechanism having a reduction gear and a first electric motor to apply a drive force to the rack shaft through the reduction gear;
a second steering mechanism having a second electric motor, a power cylinder equipped with a pair of hydraulic pressure chambers, an oil pump driven by the second electric motor to provide a supply of hydraulic oil to the hydraulic pressure chambers in such a manner that the power cylinder applies a driving force to the rack shaft in accordance with a pressure difference between the hydraulic pressure chambers and a switching unit capable of selectively switching the supply of hydraulic oil from the oil pump to the hydraulic pressure chambers; and
a control device that controls the first and second electric motors in response to a driver's steering operation.

2. The steering control apparatus according to claim 1, wherein the oil pump is a reversible pump that has a pair of discharge ports connected to the hydraulic pressure chambers, respectively, so as to selectively supply the hydraulic oil to the hydraulic pressure chambers by forward or reverse rotation thereof; and wherein the switching unit is a steering sensor that detects a direction of the driver's steering operation and outputs a signal to the control device so as to change the rotation direction of the reversible pump according to the detected direction of the steering operation.

3. The steering control apparatus according to claim 2, further comprising a pinion shaft having pinion teeth engaged with the rack teeth of the rack shaft, wherein the reduction gear is disposed on the pinion shaft.

4. The steering control apparatus according to claim 3, wherein the reduction gear includes a worm wheel having external gear teeth formed of a resin material and located on an outer periphery of the pinion shaft and a worm shaft connected to the first electric motor and engaged with the external gear teeth of the worm wheel so as to transmit the drive force from the first electric motor to the pinion shaft.

5. The steering control apparatus according to claim 2, wherein the reduction gear is disposed on the rack shaft.

6. The steering control apparatus according to claim 6, wherein the rack shaft and the power cylinder are arranged in parallel with each other.

7. The steering control apparatus according to claim 2, further comprising: a steering shaft connected to a steering wheel; and a steering column rotatable relative to the steering shaft, wherein the reduction gear is disposed on the steering column.

8. The steering control apparatus according to claim 2, wherein the second steering mechanism has a communication line to allow hydraulic communication between the hydraulic pressure chambers and a fail-safe valve to open or close the communication line.

9. The steering control apparatus according to claim 1, wherein the switching unit is a rotary valve that selectively switches the supply of hydraulic oil supply to the hydraulic pressure chambers in response to the driver's steering operation.

10. The steering control apparatus according to claim 1, wherein the switching unit is a solenoid valve that selectively switches the supply of hydraulic oil to the hydraulic pressure chambers in response to the driver's steering operation.

11. A steering control apparatus, comprising:
a rack shaft connected to steerable wheels and having rack teeth in a given axial range;
a pinion shaft connected at one end thereof to a steering wheel via a steering shaft and having pinion teeth at the other end thereof engaged with the rack teeth;
a first steering mechanism having a reduction gear and a first electric motor to apply a drive force to the rack shaft through the reduction gear;
a second steering mechanism having a second electric motor, a power cylinder equipped with a pair of hydraulic pressure chambers, an oil pump driven by the second electric motor to provide a supply of hydraulic oil to the hydraulic pressure chambers in such a manner that the power cylinder applies a driving force to the rack shaft in accordance with a pressure difference between the hydraulic pressure chambers and a switching unit capable of selectively switching the supply of the hydraulic oil to the hydraulic pressure chambers; and
a control device that controls the first and second electric motors in response to a driver's steering operation.

12. The steering control apparatus according to claim 11, wherein the oil pump is a reversible pump that has a pair of discharge ports connected to the hydraulic pressure chambers, respectively, so as to selectively supply the hydraulic oil to the hydraulic pressure chambers by forward or reverse rotation thereof; and wherein the switching unit is a steering sensor that detects a direction of the driver's steering operation and outputs a signal to the control device so as to change the rotation direction of the reversible pump according to the detected direction of the steering operation.

13. The steering control apparatus according to claim 11, wherein the switching unit is a rotary valve that selectively switches the supply of hydraulic oil to the hydraulic pressure chambers in response to the driver's steering operation.

14. The steering control apparatus according to claim 11, wherein the switching unit is a solenoid valve that selectively switches the supply of hydraulic oil to the hydraulic pressure chambers in response to the driver's steering operation.

15. The steering control apparatus according to claim 14, wherein the second steering mechanism is equipped with a reservoir tank to store therein the hydraulic oil; and wherein the solenoid valve is connected with the hydraulic pressure chambers and with the reservoir tank.

16. A steering control apparatus, comprising:
a rack shaft connected to steerable wheels and having rack teeth in a given axial range;
a first steering mechanism having a reduction gear and a first electric motor to apply a driving force to the rack shaft through the reduction gear;
a second steering mechanism having a second electric motor, a power cylinder equipped with a pair of hydraulic pressure chambers, an oil pump driven by the second electric motor to provide a supply of hydraulic oil to the hydraulic pressure chambers in such a manner that the power cylinder applies a driving force to the rack shaft in accordance with a pressure difference between the hydraulic pressure chambers and a switching unit capable of selectively switching the supply of hydraulic oil from the oil pump to the hydraulic pressure chambers;
a first switching circuit that controls a direction of energization of the first electric motor; and
a second switching circuit that controls a direction of energization of the second electric motor.

17. The steering control apparatus according to claim 16, further comprising: a first motor command calculation circuit connected to the first switching circuit to calculate an amount of energization of the first electric motor; and a second motor command calculation circuit provided separately from the first motor command calculation circuit and connected to the second switching circuit to calculate an amount of energization of the second electric motor.

18. The steering control apparatus according to claim 17, wherein the first and second motor command calculation circuits monitor each other.

19. The steering control apparatus according to claim 16, further comprising a motor command calculation circuit connected with the first and second switching circuits to calculate an amount of energization of each of the first and second electric motors.

20. The steering control apparatus according to claim 19, wherein the first and second switching circuits are arranged adjacent to the first and second steering mechanisms, respectively; and wherein the motor command calculation circuit is arranged separately from the first and second switching circuits.
